(19) United States
(12) Patent Application Publication
(10) Pub. No.: US 2003/0004587 A1
(43) Pub. Date: Jan. 2, 2003

(54) Title III digital recording system

(76) Inventors: Raymond Joseph, Grant, FL (US); Lisette Mercedes Kolar, Grant, FL (US)

Correspondence Address: Raymond Joseph Kolar, PO Box 808, Grant, FL, 32949, US

(21) Appl. No.: 09/811,267

(22) Filed: Mar. 19, 2001

(51) Int. Cl. G06F 17/00

(52) U.S. Cl. 700/94

(57) ABSTRACT

The Title III Digital Recording System is an invention to satisfy the digital recording requirements of court ordered wiretapping in accordance with newly generated legislation (CALEA, the Communication Assistance for Law Enforcement Act), and to replace inefficient Title III analog recording techniques with digital recording on inexpensive Compact Disc (CD) media. Title III refers to a generally accepted reference for legal wiretapping (telephone intercepts).

The Title III Digital Recording System is a recorder that is compliant with requirements set forth in the U.S. Code Title 18, sections 2510 et al. It provides a complete capability to support legally authorized wiretaps, and provides many features to assist the Law Enforcement professional in conducting the wiretap recording operation. The Title III Digital Recording System uniquely applies conventional Compact Disc (CD) recording techniques to specific Law Enforcement problems.

The Title III Digital Recording System allows the Law Enforcement professional to record high-fidelity intercepts on digital recording media, vs. analog tape recordings. It provides for 20 hours of recording on a single CD media. The recording technique utilizes UDF (Universal Data Formatting) on the CD's to optimize record time and data integrity. Three digital recordings are performed simultaneously: Primary Evidence CD, backup Evidence CD, and Working CD. The CDs can be played back in conventional CD R/W players supporting the Universal Data Format using Commercial-Off-The-Shelf (COTS) playback software.

### 1.0 TITLE OF INVENTION

The Title III Digital Recording System is an invention to satisfy the digital recording requirements of court ordered wiretapping in accordance with newly generated legislation (CALEA, the Communication Assistance for Law Enforcement Act), and to replace inefficient Title III analog recording techniques with digital recording. Title III refers to a generally accepted reference for legal wiretapping (telephone intercepts).

Title 18 U.S. Code actually defines current wiretapping regulations; however, the use of “Title III” is prevalent within the Law Enforcement community when describing these activities and regulations. Numerous constraints, not satisfied by available digital recording devices, are levied on the law enforcement professional in carrying out the mandates of Title 18. These include the requirements for multiple simultaneous recordings; the ability to “minimize”, or briefly terminate monitoring of the wiretap, during periods of non-relevant conversation; and various other minor requirements for record-keeping and data integrity.

The Title III Digital Recording System was co-invented by:

Raymond J. Kolar, U.S. citizenship, 5180 Red Bay Lane, Grant, Fla. 32949 and

Lisette M. Kolar, U.S. citizenship, 5180 Red Bay Lane, Grant, Fla. 32949

### 2.0 CROSS REFERENCE TO RELATED APPLICATIONS

NOT APPLICABLE

### 3.0 STATEMENT REGARDING FEDERALLY SPONSORED RESEARCH OR DEVELOPMENT

NOT APPLICABLE

### 4.0 REFERENCE TO A MICROFICHE APPENDIX

NOT APPLICABLE

### 5.0 BACKGROUND OF THE INVENTION

The Title III Digital Recording System field of endeavor is electronics surveillance instruments used by local state, and federal Law Enforcement Agencies. The Title III Digital Recording System uniquely applies conventional CD recording techniques to specific Law Enforcement problems.

Reference documents include:

A. U.S. Code Title 18, sections 2510 et al, which describes the requirements for legal wiretapping activities;

B. Communication Assistance for Law Enforcement Act (CALEA, J-STD-025), which describes newly formed specifications for access to digital telephony systems for the purpose of legal wiretapping activities.

The advent of digital technology provides problems for the legal intercept of telephony. These problems consist of:

A. Current telephony intercept systems generally accept analog input signals. Technology, and CALEA, now suggest that received telephony may be in digital form. The digital nature of the access precludes the use of conventional and current telephony equipment.

B. Current telephony intercept equipment generally operates in a monophonic mode; i.e., a single channel of telephony is recorded in analog fashion. In current two wire systems, this is satisfactory since both sides of a conversation (target and target's associate) are contained in the single channel. This is not necessarily true with the newer technologies, whereby the target and the associate may be on individual analog or digital lines.

C. Facsimile intercepts are very important to Law Enforcement agencies. However, current analog recording systems do not allow the fidelity required for post-processing and generation of intercepted facsimile data from conventional analog tapes normally used by Law Enforcement agencies. Because of this, expensive facsimile intercept systems must be individually allocated to each intercept (very expensive and resource inefficient), rather than using a single facsimile intercept system for use on collected data from a number of different target intercepts.

D. Record time for current analog recorders is very limited. For example, current analog recording systems generally use audiocassette tapes limited to one-hour record times (maximum). The problem is exacerbated by Title 18 requirements, which call for both a primary and backup recording. The frequent changing of audio analog tapes results in periodic “missed” intercepts and bookkeeping/accounting difficulties.

E. Intercepted conversations, recorded on analog tapes, are transcribed to paper format via transcription specialists. The transcription process for analog tape recordings is cumbersome, due to the slow forward/reverse control of the analog tape machine.

F. Dubbing of analog media, required, for example, in legal discovery situations, is cumbersome and time consuming when using analog media.

G. With current recording systems, it is very difficult to mark events of interest. For example, current procedures call for an event of interest (segment of tape recording with evidentiary content, beginning of a critical conversation, etc) to be marked by the operator via written format, with the time recorded. No direct correlation of the event occurs.

H. Current Law Enforcement analog recording techniques do not allow network control of resources from a single point.

### 6.0 BRIEF SUMMARY OF THE INVENTION

The Title III Digital Recording System is a recorder compliant with the requirements set forth in the U.S. Code Title 18, sections 2510 et al. It provides a complete capability to support legally authorized wiretaps, and provides many features to assist the Law Enforcement professional in conducting the wiretap recording operation

The Title III Digital Recording System allows the Law Enforcement professional to record high-fidelity intercepts on digital recording media, vs. analog tape recordings. It provides for 20 hours of recording on a single Compact Disc (CD) media. The recording technique utilizes UDF (Universal Data Formatting) on the CD's to optimize record time and data integrity. Three digital recordings are performed simultaneously: Primary Evidence CD, backup Evidence CD, and Working CD. The CDs can be played back in conventional CD R/W players supporting the Universal Data Format using Commercial-Off-The-Shelf (COTS) playback software.

The Title III Digital Recording System can be used as a standalone recorder, with front panel control (MODE 1); or as a standalone recorder with computer control (MODE 2). A computer interface is provided in both modes that allows external Case Data to be provided to the Title III Recorder.

A third mode of operation allows the Title III Digital Recording System to be integrated with external Dial Number Recognizer (DNR) machines (MODE 3). In this mode, the entire collection process can be controlled via the external computer.

A fourth mode of operation allows DNR equipment to be integrated with the Title III Recorder (MODE 4). In this mode, the entire collection process can be controlled via the Title III Digital Recording System computer.

The Title III Digital Recording System solves existing problems. Specifically, and referring to Section 5:

A. Current telephony intercept systems generally accept analog input signals. Technology, and CALEA, now suggest that received telephony may be in digital form. The digital nature of the access precludes the use of conventional and current telephony equipment.

The Title III Digital Recording System allows the recording of digital intercepts directly onto digital media.

B. Current telephony intercept equipment generally operates in a monophonic mode; i.e., a single channel of telephony is recorded in analog fashion. In current two wire systems, this is satisfactory since both sides of a conversation (target and target's associate) are contained in the single channel. This is not necessarily true with the newer technologies, whereby the target and the associate may be on individual analog or digital lines.

The Title III Digital Recording System allows stereo analog recording, with either analog or digital signals. The Title III Recorder allows n-channel recording with digital input.

C. Facsimile intercepts are very important to Law Enforcement agencies. However, current analog recording systems do not allow the fidelity required for post-processing and generation of intercepted facsimile data from conventional analog tapes normally used by Law Enforcement agencies. Because of this, expensive facsimile intercept systems must be individually allocated to each intercept (very expensive and resource inefficient), rather than using a single facsimile intercept system for use on collected data from a number of different target intercepts.

The Title III Digital Recording System allows for high fidelity recording of intercepted analog or digital signals. The fidelity is sufficient to recover intercepted facsimile signals from the recorded CD media.

D. Record time for current analog recorders is very limited. For example, current analog recording systems generally use audiocassette tapes limited to one-hour record times (maximum). The problem is exacerbated by Title 18 requirements, which call for both a primary and backup recording. The frequent changing of audio analog tapes results in periodic “missed” intercepts and bookkeeping/accounting difficulties.

The Title III Digital Recording System allows 20 hours of record time on a single CD. When operating in a non Title III mode (multiple simultaneous recordings not required), the recorder can “cascade” the recording, allowing 60 hours of digital recording before changing CDs. (20 hours per CD)

E. Intercepted conversations, recorded on analog tapes, are transcribed to paper format via transcription specialists. The transcription process for analog tapes is cumbersome, due to the slow forward/reverse control of the analog tape machine.

The Title III Digital Recording System records in conventional digital formats (WAVE files, or others). Consequentially, the playback of selected segments does not require mechanical forward or reverse tape motion. Any segment of the intercept can be accessed via COTS playback software via a simple “point and click operation”.

F. Dubbing of analog media, required, for example, in legal discovery situations, is cumbersome and time consuming when using analog media.

Dubbing of the Title III Digital Recording System intercepts can be performed simply with COTS software. It involves only the copying of files from one CD to another CD. Further, using COTS software, specific segments of interest can be easily selected and “dubbed” by copying to another file, and subsequently to CD.

The CD can be made even more accessible by “closing out” to ISO format, vs. the Universal data Format. In this case, the CD can be read by virtually any CD player in modem computers.

G. With current recording systems, it is very difficult to mark events of interest. For example, current procedures call for an event of interest (segment of tape recording with evidentiary content, beginning of a critical conversation, etc) to be marked by the operator via written format, with the time recorded. No direct correlation of the event occurs.

The Title III Digital Recording System allows the marking of events by depressing a front panel button or keyboard interaction. Each event is time tagged, and recorded on the CD along with the intercept audio. Because of the digital recording technique, the time of each audio sample can be directly correlated to the Event time.

H. Current Law Enforcement analog recording techniques do not allow network control of resources from a single point.

With the Title III recording System, individual recorders can be linked over a network. Multiple recorders can be controlled from a single remote computer, located either on the local network or externally over the INTERNET.

### 6.0 BRIEF DESCRIPTION OF THE SEVERAL VIEWS OF THE DRAWING

NOT APPLICABLE

### 7.0 DETAILED DESCRIPTION OF THE INVENTION

The Title III Recorder is capable of operating in the following modes of operation.

1. MODE 1. Standalone Mode, no monitor or keyboard

In this mode, the Title III Recorder accepts remote start inputs from an external DNR or other source. The recorder front panel (Touch Screen) minimization control is used for minimization control. All target intercept data outputs (call initiation, start/stop time, etc) is generated by the Recorder. No data interface exists with the external DNR. All operator control is via the Recorder Front Panel Touch Screen.

2. MODE 2—Standalone Mode, with monitor and keyboard

In this mode all operator control (except headphone and speaker volume and balance) is via the monitor/keyboard and mouse. Local Front panel operation is disabled (display shall show REMOTE, or alternatively, the Touch Screen may be removed)

3. MODE 3—Remote Mode with Computer Control

This mode is similar to Mode 2, except control is via an application resident on a separate PC. Communication is via TCP/IP. This mode also allows the capability for control of multiple recording resources over a network. The network can be either local (e.g. ETHERNET) or external (recorder control over the INTERNET);

Variations of these modes are allowed. For example, control may be via software hosted on an external DNR computer, or the DNR may be hosted within the recorder, resulting in an integrated collection system.

The Standalone recorder configuration (Mode 1), with front panel operation, is shown in FIG. 7.0-2. In this configuration, the recorder accepts analog or digital intercept audio from a collection source. A remote start command may be provided by a separate collection device (DNR, etc), or the operator may manually start the recorder. The operator controls the Title III Recorder via the front panel, and is able to monitor the intercept, adjust the recorder, and produce CD's containing Intercept Data and audio. The Intercept Data may also be printed on an optional data logger.

The minimization process is performed by either the DNR or the Title III recorder. Minimization is a Law Enforcement term, denoting the cessation of recording and monitoring during periods of non-evidentiary intercept. The operator, when determining that the intercepted conversation is not relevant to the case, “minimizes” the conversation (shuts off the monitor and record functions). Periodically, the operator revisits the intercept to determine if the conversation is relevant.

[image]

### FIG. 7.0-2 Title III Recorder in Mode 1 Standalone Configuration, Front Panel Control

The Standalone recorder configuration, with computer monitor and keyboard, is shown in FIG. 7.0-3. In this configuration, the recorder accepts analog or digital intercept audio from a collection source. A remote start command may be provided by a separate collection device (DNR, etc). The operator controls the Title III Recorder via the computer, which allows the operator additional capabilities. These include entering case data for recording generating reports increased playback capabilities and additional control functions. Utility programs (disc formatters, word processors, etc) may also run simultaneously with the recorder software.

[image]

### FIG. 7.0-3 Title III Recorder in Standalone Configuration Mode 2, with Computer Monitor and Keyboard

The Remote Recorder configuration (MODE 3), with remote computer control, is shown in FIG. 7.0-3. In this configuration, the recorder accepts analog or digital intercept audio from a collection source. A remote start command may be provided by a separate collection device (DNR, etc). The operator controls the Title III Recorder via the computer, which allows the operator additional capabilities. These include entering case data for recording generating reports increased playback capabilities and additional control functions. Utility programs (disc formatters, word processors, etc) may also run simultaneously with the recorder software.

[image]

FIG. 7.0-4 Title III Recorder in Remote Configuration Mode 3, with External Computer Control

[image]

### FIG 7.0-3 Title III Recorder in Standalone Configuration Mode 2, with Computer Monitor and Keyboard

The Remote Recorder configuration (MODE 3), with remote computer control, is shown in FIG. 7.0-3. In this configuration, the recorder accepts analog or digital intercept audio from a collection source. A remote start command may be provided by a separate collection device (DNR, etc). The operator controls the Title III Recorder via the computer, which allows the operator additional capabilities. These include entering case data for recording generating reports increased playback capabilities and additional control functions. Utility programs (disc formatters, word processors, etc) may also run simultaneously with the recorder software.

[image]

### FIG. 7.0-4 Title III Recorder in Remote Configuration Mode 3, with External Computer Control

This mode also allows the common control of multiple recorders from a single computer, or over the INTERNET. This capability is illustrated in FIG. 7.0-5.

[image]

### FIG. 7.0-5 Title III Recorder in Remote Configuration Mode 3, Illustrating Network Capability

7.1 Title III Recorder Characteristics

7.1.1 Functional Characteristics

7.1.1.1 Number of CD Recorders

Three CD recorders are provided. The CD recorders simultaneously record the processed audio input signal. The first recorder is termed the “Original” Recorder, and provides the master recording for traceability. The second recording, termed the “Second Original”, is a backup to the Original recording. The Original and Second Original recordings are identical. The third recording is a working copy that can be used by the case officers as required.

7.1.1.2 Media Characteristics

CD-R media is used for the Evidentiary and Backup CD recorders. A CD R/W may be used for the Working Copy CD recording.

7.1.1.3 Record Cut (File) Formats

A single format is provided that will record standard WAV files. These discs will not be playable in standard computer playback devices. The disks are recorded in UDF format. All disks used must be pre-formatted to UDF. After recording, conventional software packages may be used to convert the UDF formatted disc to standard CD formats that can be read by most CD players.

7.1.1.4 Record Start/Stop

A remote only record start capability is provided. The record start input is configurable for normally closed (NC) start, normally open (NO) start, TTL (logic level) high, or TTL (logic level) low start capability.

A local remote start capability is provided. Local remote start has the capability to be disabled.

7.1.1.5 Data Verification

Data verification is performed by the Title III Recorder.

7.1.1.6 Record Mode

The Title III Recorder has the capability to record in the following modes:

a. Internal Linear PCM (pulse code modulation)

b. Internal Companded PCM

c. Compressed

d. External PCM (CALEA Interface)

7.1.1.6.1 Internal linear PCM

The Title III Recorder digitizes the intercepted analog audio to a resolution of 8 or 16 bits. The sample rate is 8, 11.025 or 22.050 ksamples/sec. This mode (internal linear PCM) is the baseline mode of operation for the standalone Title III recorder. This mode provides the highest quality recording possible.

Four linear PCM recording sub-modes is provided: Fair, Good, Better and Best, with the following basic characteristics (others may be programmed):

| | |
|---|---|
| Fair: | 8 bits per sample, 8 ksamples per second |
| Good: | 8 bits per sample, 11.025 ksamples per second |
| Better: | 16 bits per sample, 11.025 ksamples per second |
| Best: | 16 bits per sample, 22.050 ksamples per second |

7.1.2.6.2 Internal Companded PCM

Standard A Law or u Law companding may be provided.

7.1.1.6.3 Compressed

Conventional compressing schemes may be provided.

7.1.1.6.4 External PCM

The Title III Recorder has the capability to accept external PCM data via ETHERNET port (TCP/IP) for recording.

7.1.1.7 Minimization

The operator can “Minimize” (pause) an intercept. Upon minimization, the recording of the intercept is halted. Minimization applies to the local start as well as the remote start function.

Three Minimization techniques are provided: No dead space between minimization start /stop; two seconds silence between minimization start/stop; and actual silence time between minimization start/stop.

This capability can be disabled via the set up menu. This would occur when the remote DNR controls the minimization function.

7.1.1.8 Headphone/speaker Monitor Audio Selection and Gain

Independent gain and balance controls is provided for each of the two headphone outputs and the speaker port.

7.1.1.9 Internal/External speaker

An internal speaker is provided within the Title III Recorder. An external speaker jack is provided that will disconnect the internal speaker when an external speaker is connected.

7.1.1.10 Time of Day

The user can input (via the front panel) Day of Year (DOY) and Time of Day (TOD). The Recorder also accepts TOD updates via the external data interface.

7.1.1.11 Data Logger

A Data Logger function is provided that will allow for the printing of intercept data or logging to floppy disk. Each intercept printout shall contain DOY, TOD, case data and intercept data for each intercept. The BookKeeper data is accessible at a standard serial communications interface and/or parallel port. The attachment of a print device is optional, and must be a “line’ oriented printer.

7.1.1.12 Manual Record Start

The operator can manually start and stop recording (in addition to the remote start capability. This function can be disabled via the set up menu.

7.1.1.13 Alarms

Both audible and visual alarms are provided to warn the operator of an alarm condition. Only the audible alarm can be muted for a given alarm condition. The visual alarm remains until the alarm condition is cleared.

7.1.1.14 Internal Disc Storage and Intercept Data Backup

The internal disc is conventional HD (Hard Disc) technology. The contents of the Original CD is “shadowed” in this internal disc as a safety measure in the event of CD failure. The failsafe measure allows recovery only via authorized factory representatives.

7.1.1.15 Associated Data

Each audio intercept file has Target intercept data associated with it, consisting of identification number, time and date stamp, and other recorder event data. If provided by an external DNR or other device, Subject and Case data is also included.

7.1.1.16 Case and Subject Data A Case Data Structure is generated and provided on each Evidentiary CD. The Case Data can be provided on the CD, and as BookKeeper output. This case data is recorded only if a remote connection to the Recall DNR or other device is provided and the case/subject data is downloaded.

The Case and Subject Data Structure is CALEA compatible, if applicable.

7.1.1.17 Target Intercept Data

A Target Intercept Data Structure is generated and provided on all CDs. The Intercept Data is provided on the CD, and as BookKeeper output. The Intercept Data is created autonomously by the Title III Recorder, and no computer connection is necessary.

The Intercept Data can also be reviewed at an appropriate computer workstation.

Items in the target Intercept data consist of recorder event and Time/date stamp.

7.1.1.18 Default Restart

In a Default Restart, the Title III recorder restarts in the previous power on condition. The data is stored on the Title III Recorder hard disc.

7.1.1.19 Disc Identification Number

Each CD inserted into the system is assigned a pseudo-unique CD identification number. The number is recorded onto the CD and “lives” with the CD for the life of the CD. The number is a unique identifier, consisting of Title III Recorder ID (unique to unit), disc type number (1,2 or 3) and sequential ID number (0 to 255).

7.1.1.20 Alarm Condition

Multiple alarm sounds and durations are selectable by the user.

7.1.1.21 Lockout

A password scheme is used to lock critical functions of the front panel and menu. There is a Administrator level, with full capability, and a user level with limited capability. The protection is implemented with a floppy disc “key’. Administrator functions are accessed only if the proper “key’ disc is inserted into the floppy drive.

7.1.1.22 Clock Synchronization

A capability is provided to synchronize the recorder clock with the external DNR clock.

7.2 Performance Characteristics

7.2.1 Record Time

Record time is a function of selected compression and/or recording technique. The estimated record time as a function of record quality is shown below. The figures assume 600 Mbytes usable disk space, allowing 50 Mbytes for overhead.

| RECORD QUALITY | MONO | STEREO |
|---|---|---|
| Fair (8 ks/sec, 8 bits/sample) | 20.8 hours | 10.4 hrs |
| Good (11.025 ks/sec, 8 | 15.11 | 7.5 |
| bits/sample) | | |
| Better (11.025 ks/sec, 16 | 7.55 | 3.77 |
| bits/sample) | | |
| Best (22.050 ks/sec, 16 | 3.77 | 1.88 |
| bits/sample) | | |

7.2.2 Record Quality

Record quality is sufficient for the recovery of modem and Fax intercepts.

7.2.3 Recorder Audio Outputs

Audio outputs maintain the quality of the audio input.

7.2.4 Sample Rate/sample size

Four linear PCM recording sub-modes are provided: Fair, Good, Better and Best, with the following characteristics:

| | |
|---|---|
| Fair: | 8 bits per sample, 8 ksamples per second |
| Good: | 8 bits per sample, 11.025 ksamples per second |
| Better: | 16 bits per sample, 11.025 ksamples per second |
| Best: | 16 bits per sample, 22.050 ksamples per second |

7.2.5 Time of Day

Time of Day is kept to an accuracy of better than ±15 minutes per year. A battery backup is provided to maintain the TOD function when the Recorder is not connected to AC or DC power. The battery lifetime is greater than three years.

7.3 Hardware and Software Architecture

A block diagram of the Title III Digital Recording System is shown in FIG. 7.3-1. The Recorder consists of hardware and software items.

Hardware items consist of the Recorder Unit and optional Remote Control computer.

The Recorder Unit is a single chassis. The recorder Unit contains the Recorder Circuit Card Assembly (CCA), the Single Board Computer, Display, Power Supply, CD drives, conventional hard drive, and floppy drive.

The Recorder CCA is a unique hardware design containing audio processing circuits

The display is a Commercial-Off-The-Shelf (COTS) TouchScreen Liquid Crystal Display (LCD) display and controller

The Single Board Computer is a COTS Personal Computer (PC0. It can be either an ATX or micro-ATX motherboard or a PCI plug-in board type computer. Depending on the specific board selected, additional boards (video, network, sound, etc) may be required.

The Power supply, CD Drives, hard drive and floppy drive are all COTS items

The optional remote Control computer can be any modern Windows® compatible PC. Software items consist of the CD Controller Software Application, the Recorder Circuit Card Assembly (CCA) Software Application, and the User Interface Software Application.

The CD Controller Application is resident on the Single Board Computer within the Recorder Unit. The CD Controller Software Application controls digitizing of analog audio, the input of digital audio data, and the placement of that data onto the CD recording media. It also maintains the Recorder Database and all configuration data items.

The Recorder CCA Software Application is resident on the Recorder CCA within the Recorder Unit. The software is resident on a micro-controller integrated circuit located on the Recorder CCA. The Recorder CCA Software Application controls the analog audio processing. (Each recorder has a number of headphone and speaker outputs for monitoring of the intercept).

The User Interface Software Application is resident on either the Single Board computer within the Recorder Unit (Standalone Modes 1 and 2) or the optional Remote Control Computer (Remote Mode 3).

[image]

7.3.1 Hardware Architecture

The hardware architecture is based on a standard PC architecture. The custom-designed Recorder CCA is integrated within this architecture.

7.3.2 Software Architecture

The Software architecture takes advantage of existing Windows® operating system capabilities, and other COTS software (for example, the Adaptec DirectCD® CD driver software. Title III Recorder unique software integrates these available software capabilities with Tile III Recorder developed software to produce a Law Enforcement specific recording capability. The software architecture of this custom software is described in the following paragraphs.

7.3.2.1 CD Controller Software Architecture

The CD Controller software interfaces are shown in FIG. 7.3.2.1-1. The CD Controller software receives a power up signal, either via Windows® or operator initiation. The overall recorder is powered down either by operator interaction via the User Interface, or via a Windows® shutdown selection. In either case, the CD Controller Software Application will gracefully shutdown and preserve any recordings in process. The CD Controller Software Application communicates with both the Recorder CCA Software Application and the User Interface Software Application for Control and Status. The CD Controller Software Application writes data to the CD's.

[image]

The CD Controller Software Application architecture is shown in FIG. 7.3.2.1-2 and described in the following paragraphs. Each “bubble” equates to a major function implemented in software.

[image]

The CD Controller Software Application is started in one of three ways: automatically at recorder power up (the CD Controller Software Application executable is placed within the Windows® Startup folder), or by operator action at a keyboard/monitor (selecting the CD Controller Software Application via normal Windows® operation).

Initialization:

An initialization sequence occurs. During this time, configuration data and flags are read from an initialization file. These flags describe the settings for the application. examples include pre-settable record volumes, record paths (line, microphone, etc), record qualities, mono/stereophonic selection, etc). The various communications ports (Serial communications, TCP/IP) are initialized. The current status of all recorded CD media is analyzed.

CD Controller Software Application LOOP:

The CD Controller Software Application LOOP function handles all ongoing events, messages and processing. It responds to all internal and external events by calling appropriate software routines. These routines are described in the following paragraphs.

Search For Discs, Update Disc Information:

Insertion or extraction of any of the three CD's results in an event that is processed by these functions. The event type is determined, and appropriate action is take.

Send A Message to the User Interface SW:

Process Incoming Message from the User Interface SW:

These functions process the Control and Status associated with the User Interface SW. The complete set of capabilities is available via this TCP/IP interface.

Send A Message to the Recorder CCA SOFTWARE:

Process Incoming Message from the Recorder SW:

These functions process the Control and Status associated with the Recorder CCA SOFTWARE. Hardware control of audio path, minimization, audio gains and other related items is provided via this serial interface.

Create New MMIO File:

This function creates the file structure when a new recording is started. It generates the file headers, trailers, and names the new file.

Record functions, consisting of:

Start Record:

This function initiates the recording process, and begins the digitization and creation of sampled data blocks. The data blocks are created in conformance with standard WAVE formats, and are double-buffered to prevent any loss of data The digitization is performed by a standard soundcard integrated circuit that is common to most Windows® computers.

Record Block:

A buffer is recorded once per 10 seconds. This function performs the actual recording of the buffer, and the control of buffer selection for the digitizer.

Continue Record New File:

To ensure compatibility with other recorder playback devices, the size of each WAVE file is limited to a settable value (e.g., 5 or 10 minutes). If a recording continues beyond this period, the current file is closed out, and a new file created. The new file is identical to the previous, except for an attached continuation number. In this way, the user may record multiple hours of intercept data without any loss of data.

Pause Record:

The Pause Record function pauses the recording when the operator selects “Minimize” (a desire to suspend monitoring and recording during non-relevant portions of the intercept, a Title 18 requirement).

Resume Record:

After release of Minimization, the recording resumes. This function also inserts the desired Minimization flag into the recording. This flag can be:

No flag, resume recording with contiguous samples

Insert two seconds of silence between the Pause and Resume samples of the recording

Insert actual Pause to Resume dead time number of samples

Stop Record:

This function stops the recording, and closes out the audio and data files.

ShutDown Processing:

Upon power-down of the recorder, this function gracefully exist (closes recording files if open, ensuring no loss of data) and shuts down the Windows® operating system.

7.3.2.2 User Interface Software Architecture

The User Interface Software Application resides either within the Recorder Unit (Standalone Modes1 or 2), or within the Remote Computer (Remote Modes 3 or 4). The same application is used, but with a different set of configuration flags contained in an initialization file.

The User Interface software application interfaces are shown in FIG. 7.3.2.2-1. The software receives a power up signal, either via Windows® or operator initiation. The User Interface Software Application is powered down either by operator interaction via the User Interface, or by a Windows® shutdown selection. In either case, the User Interface Software Application will gracefully shutdown and preserve any recordings in process. The User Interface Software Application communicates with the CD Controller Software Application via a TCP/IP link.

[image]

### FIG. 7.3.2.2-1 User Interface Application Software Interfaces

The User Interface is implemented by a set of display and operator selectable buttons (selectable either via touch on the Touchscreen display, or by way of mouse clicking on a keyboard/monitor/mouse configuration).

Four main windows, and a number of sub-screens, provide full operating capability to the user. The four main screens consist of the Operate, User, Playback and Admin windows.

As an illustration of the User Interface “look and feel”, the Windows will be shown and briefly described in the following paragraphs.

The Operate Window is shown in FIG. 7.3.2.2-2. This window:

Allows navigation to the other main windows (USER, PLAYBACK, ADMIN)

Provides Time Of Day

Provides a Recorder System status area (in the case of the figure, the recorder is ready and waiting to record. Other messages will be displayed during the use of the recorder.

Shows the status of the three CD's (in the case of the figure, Disc 1 is not inserted. Disc 2 shows a LOW! indicator, indicating that the disc is low on space. Disc 3 also indicates that no disc is inserted. It is yellow, vs red, because it is a “non-critical” working disc, vs a “critical” evidentiary Disc.)

A VU Meter, showing record levels

A Start Manual Record button

A Show Percent Full button (The remaining time 00:19, or 19 minutes is displayed in the status area for disc 2. Pressing the SHOW PERCENT button changes this display to % of disc space utilized.)

TRACK status area: Track number (sequential identifier of recorded tracks)

INDEX status area: (blank, but shows time after record start).

PAUSE status area: (blank, but shows time during minimization)

Event Marker button (cone) (activated during recording, allows the marking of an event time)

Minimization button (speaker) (activated during recording, allows for the Minimization, or pausing, of the recording process.

[image]

The User Window is shown in FIG. 7.3.2.2-3. This window:

Allows adjustment of record level

Sets the disc full threshold (alarm will be generated when disc exceeds this threshold)

Enables or disables the Audible alarms

[image]

[image]

The User Window is shown in FIG. 7.3.2.2-3. This window:

allows adjustment of record level

Sets the disc full threshold (alarm will be generated when disc exceeds this threshold)

Enables or disables the Audible alarms

[image]

The Playback Window is shown in FIG. 7.3.2.2-4. This window:

Shows the recorded audio files on each disc

Allows navigation to a desired file by use of PAGE and TRACK up/down arrows

Allows PLAY, PAUSE and STOP capabilities for the selected file.

[image]

The Administration windows allow access to the lower level Administration windows. FIG. 7.3.2.2-5 shows the Record Quality Administration Window. This window allows the selection of Record Quality, and selection between monophonic or stereo recording.

[image]

The Playback Window is shown in FIG. 7.3.2.2-4. This window:

Shows the recorded audio files on each disc

Allows navigation to a desired file by use of PAGE and TRACK up/down arrows

Allows PLAY, PAUSE and STOP capabilities for the selected file.

[image]

The Administration windows allow access to the lower level Administration windows. FIG. 7.3.2.2-5 shows the Record Quality Administration Window. This window allows the selection of Record Quality, and selection between monophonic or stereo recording.

[image]

FIG. 7.3.2.2-6 shows the I/O Options Administration Window. This window allows the selection of Record Source (microphone, line or CALEA Digital), enabling of Remote Start functions, and selection of Remote Start modes. In the figure, the Remote start capabilities are disabled, and the Record Source is locked to Line input.

[image]

FIG. 7.3.2.2-7 shows the System Administration Window. This window allows the enabling of Manual Record Starting and Minimization, and selection of Minimization type.

[image]

FIG. 7.3.2.2-6 shows the I/O Options Administration Window. This window allows the selection of Record Source (microphone, line or CALEA Digital), enabling of Remote Start functions, and selection of Remote Start modes. In the figure, the Remote start capabilities are disable, and the Record Source is locked to Line input.

[image]

FIG. 7.3.2.2-7 shows the System Administration Window. This window allows the enabling of Manual Record Starting and Minimization, and selection of Minimization type.

[image]

FIG. 7.3.2.2-8 shows the Set Time Administration Window. This window allows the setting of Title III Recorder time and date.

[image]

FIG. 7.3.2.2-9 shows the Config Files Administration Window. This window allows the storing and recovery of configuration (setup) files.

[image]

FIG. 7.3.2.2-8 shows the Set Time Administration Window. This window allows the setting of Title III Recorder time and data.

[image]

FIG. shows the Config Files Administration Window. This window allows the storing and recovery of configuration (setup) files.

[image]

The User Interface software architecture is shown in FIG. 7.3.2.2-3 and described in the following paragraphs. Each “bubble” equates to a major function implemented in software.

[image]

Initialization:

An initialization sequence occurs. During this time, configuration data and flags are read from an initialization file. These flags describe the settings for the application, including configuring the User Interface Software Application for Standalone (TouchScreen) or remote (computer display/keyboard/mouse) operation. The TCP/IP port is initialized..

User Software Application LOOP:

The User Software Application LOOP function handles all ongoing events, messages and processing. It responds to all internal and external events by calling appropriate software routines. These routines are described in the following paragraphs.

Send A Message to the CD Controller Software Application:

Process Incoming Message from the CD Controller Software Application:

These functions process the Control and Status associated with the CD Controller Software Application.

User Interface:

This function process the elements of the graphics user interface. It is distributed among multiple sub-functions. The functionality consists of four main operating windows, 8 sub-windows, and several warning/informational dialog boxes. The functional is summarized below in list form.

OPERATE WINDOW: Disc status, manual record control, Minimization control, Event marking control, Time status, VU meter, Recorder status, Track(file) number, record time and pause time status.

USER WINDOW: VU Meter, Record Level adjustment, disc threshold settings (for low disc alarm), audible alarm control.

PLAYBACK WINDOW: Disc selection, list of files available for playback display, Track selection, Play, Pause and Stop controls.

ADMIN WINDOW: Contains the following sub-windows:

RECORD QUALITY WINDOW: Sample rate and size selection, mono/stereo selection

I/O OPTIONS WINDOW: Source of audio signal selection, Remote Start options

SYSTEMS WINDOW: Enable/disable Manual Recording, Enable/disable Minimization capability, select minimization type

SET TIME WINDOW: Time and date selection.

CONFIG FILES WINDOW: Store and/or recall operator generated configuration files

7.3.2.3 Recorder CCA Software Architecture

The Recorder CCA Software Application resides on the Recorder Circuit Card Assembly (CCA) within the Recorder System.

The Recorder CCA Software Application interfaces are shown in FIG. 7.3.2.3-1. The Recorder CCA Software Application automatically starts when power is applied to the Recorder CCA.. The Recorder CCA Software Application communicates with the CD Controller Software Application via a serial (RS 232C) link. The Recorder CCA Software Application, resident on a micro-controller integrated circuit, controls hardware settings on the Recorder CCA.

[image]

The Recorder CCA Software Application architecture is shown in FIG. 7.3.2.3-2. and described in the following paragraphs.

[image]

The Recorder CCA Software Application interfaces are shown in FIG. 7.3.2.3-1. The Recorder CCA Software Application automatically starts when power is applied to the Recorder CCA.. The Recorder CCA Software Application communicates with the CD Controller Software Application via a serial (RS 232C) link. The Recorder CCA Software Application, resident on a micro-controller integrated circuit, controls hardware settings on the Recorder CCA.

[image]

The Recorder CCA Software Application architecture is shown in FIG. 7.3.2.3-2. and described in the following paragraphs.

[image]

Initialization:

An initialization sequence occurs. During this time, configuration data and flags are read from Read only memory (ROM). These flags describe the settings for the application, including configuring the individual hardware components on the recorder CCA.

Recorder CCA Software Application LOOP:

The recorder CCA Software Application LOOP function handles all ongoing events, messages and processing. It responds to all internal and external events by calling appropriate software routines. These routines are described in the following paragraphs.

Send A Message to the CD Controller Software Application:

Process Incoming Message from the CD Controller Software Application:

These functions process the Control and Status associated with the CD Controller Software Application.

Recorder CCA Hardware Control and Status:

This function controls the hardware elements of the Recorder CCA. This functionality includes:

Select audio input source (line, microphone or digital)

Adjust record level

Record or Playback selection

Hardware VU Meter setup and monitoring

Configuration of serial controller

Minimization control of audio paths (record, headphones, speaker)

Enable and select remote start in configuration

Enable and select remote start out configuration

### 8.0 CLAIMS

The following claims are made to the Title III Digital Recording System.

What we claim our invention is:

1. A Digital Recording System for Law Enforcement applications, and satisfying the requirements of Title 18 U.S.C. Specifically;
A unique application of conventional CD recording for Law Enforcement, using common Compact Disc (CD) media rather than analog tape or other less common, and more expensive, digital media (Magneto-optic or flash memory).
Incorporation of features that allow the use of such conventional devices for Title 18 U.S.C. wiretapping operations. These features include Remote Start recording capability, Minimization capability, timeliness of recording, fidelity of recording, and recording on multiple media (CD's) to maintain the evidential quality of the wiretap.

2. The Digital Recording System allows significant additional functionality over current Analog Systems. Specifically:
Provides an integrated recording system, with all controls accessible from an easy-to-use graphics interface.
Recording of CALEA digital data onto common UDF formatted CD's.
An enhanced technique for dubbing of events and minimization marking, with multiple techniques for minimization marking.
The ability to remote Recorder control over the Internet.
Ease of playback, dubbing and transcription due to the digital recording technique and media.
Monophonic or Stereo capability.

3. The Digital Recording System allows significantly improved performance over current Analog Systems. Specifically:
Increased record times (20 hours vs. 60 minutes for an analog cassette system) on a single CD
Greater fidelity (limited only by the Analog/Digital conversion and circuitry noise), that will allow the recording and subsequent reproduction of facsimile and other modem signals.
